(19) United States
(12) Patent Application Publication
(10) Pub. No.: US 2012/0103541 A1
(43) Pub. Date: May 3, 2012

(54) Privacy Screen for Deck Railing

(76) Inventors: Linda Maxwell, Blaine, WA (US); Andrew Maxwell, Blaine, WA (US)

(21) Appl. No.: 13/248,972

(22) Filed: Sep. 29, 2011

Related U.S. Application Data
(60) Provisional application No. 61/407,520, filed on Oct. 28, 2010.

(51) Int. Cl. E06B 9/60; E06B 9/44

(52) U.S. Cl. 160/315; 160/323.1

(57) ABSTRACT

Disclosed is a retractable weatherproof blind that extends across an existing railing system of a deck or balcony. The device originates from a first spindle and connects an outstretched length of blind to a second spindle to afford weather protection and privacy. The device is quickly deployable, thereby enabling users to enjoy the sun, breeze and the view, or to provide a level of privacy and protection therefrom as desired. The device can be installed without modification to the existing deck or balcony railing, and can be quickly set up or taken down as desired. The present invention may be used on residential and commercial decks and balconies, including either tubular spindle railings or on glass railing systems.

### CROSS REFERENCE TO RELATED APPLICATION

This application claims the benefit of U.S. Provisional Application No. 61/407,520 filed on Oct. 28, 2011, entitled “RailBlinds.”

### BACKGROUND OF THE INVENTION

1. Field of the Invention

The present invention relates to railings on outdoor decks and balconies. More specifically, the present invention pertains to a retractable privacy screen useable on balcony and deck railings to protect against the elements, and to provide privacy for the user.

Many modern homes have outdoor decks or balconies connected to their structure. Decks and balconies are flat, weight supporting surfaces that are generally elevated above the ground. Because they are elevated, many utilize a hand railing system for safety. A railing provides stability and support for users, and further prevents users from falling over an unguarded edge. Some railings are made from glass such that users can enjoy an unobstructed view and be provided protection from the wind and other weather elements. Glass railings, however, are difficult to maintain and keep clean, and often become foggy in humid conditions. In addition, glass does not allow a breeze to pass therethrough on a hot day.

The drawbacks associated with glass railings cause many users to opt for a tubular railing system that incorporates vertical spindles. This design requires little in the way of maintenance, and does not require vigilant cleaning. While spindle railings solve many of the issues associated with glass railings, they do not allow for protection from the wind and outdoor elements, nor do they provide privacy from onlookers.

The present invention utilizes a unique design that is attachable to a railing system that can be easily deployed to protect against outdoor elements and to provide a level of privacy for the user. The device may be used in conjunction with residential and commercial decks and balconies, including both open rail and glass rail systems. The design comprises a retractable weatherproof blind that extends across the existing railing system, originating from a first spindle and connecting an outstretched length of blind to a second spindle to afford weather protection and privacy. The device can be installed without modification to the existing deck or balcony, and can be set up or taken down in a short amount of time.

2. Description of the Prior Art

Several devices have been disclosed in the art that attempt to protect users from outdoor elements and weather conditions. Brungelson, U.S. Pat. No. 5,024,479 discloses a retractable sun screen for a vehicle windshield, including a flexible sheet normally rolled into a helical configuration on a roller located within a tubular housing. The flexible sheet can be unwound from the roller to extend along the windshield, thereby shielding the vehicle interior surfaces from solar rays, and for keeping the inside of vehicle cooler. While the vehicle is being driven the flexible sheet is retracted into the tubular housing. Bourne, U.S. Pat. No. 1,012,239 discloses a windshield adapted for use on automobiles and other vehicles for protecting the occupants against wind and storms. The device is capable of being raised to desired heights and lowered therefrom. Effle, U.S. Patent Application, Publication No. 2008/0099158 discloses a portable beach windscreen for blocking the sun, wind and sand. While these devices provide protection from various outdoor elements, they are not designed for installation on a deck or balcony railing, wherein attachment to a vertical spindle or post is necessary.

Other devices disclosed in the prior art are designed to protect outdoor decks and windows from the wind and sun. Gower, U.S. Pat. No. 6,176,050 discloses a device for protection of property against high winds constructed from a flexible screen of predetermined strength and stretch characteristics, and in the form of a curtain utilized to protect the side of a structure including its windows and doors from the strong winds and debris impacts occurring during a hurricane. The device is anchored in a manner to space it out from the area being protected according to formula provided, and can safely dissipate substantial impacting energy. Devices such as this are designed for protection from extreme weather conditions, and are not intended for everyday use in a residential setting.

Several designs disclose a device to protect outdoor decks from the elements. Nowell, U.S. Pat. No. 7,222,467 discloses a frame assembly for at least partially enclosing a raised floor structure, including a bottom frame member positioned adjacent from an associated raised floor structure. A pair of spaced apart side frame members is connected to and extends upwardly from the bottom frame member. A top frame member is spaced from the bottom frame member and connected to the pair of side frame members. A screen is selectively mounted to at least one of the top and bottom frame members and the side frame members. Williams, U.S. Pat. No. 6,942,002 discloses an enclosure for selected areas of a property from viewing by strangers. Screen rolls are provided which can be strung between the telescoping members when they are raised to a height desired by the user to screen an area from strangers to the owners of the property. The telescoping members may be driven between raised and lowered positions by a motor or a hand crank. In one embodiment, the structure is associated with a deck which may extend from a house, in which case the canisters may be secured to the deck floor or legs of the deck. While these devices serve their intended purpose, they require permanent installation on a deck and railing, and require significant time and effort for installation and removal.

The present invention overcomes the difficulties encountered in the prior art by utilizing a unique design that is attachable to existing deck railing systems without requiring permanent installation, making it easily installable and removable. The device is retractable, allowing for quick set up and take down as desired. The weatherproof material provides protection from the wind and other elements, while also obscuring vision therethrough to provide a level of privacy for a user. The present invention substantially diverges in design elements from the prior art and consequently it is clear that there is a need in the art for an improvement to existing retractable privacy and weather screens for deck and balcony railings. In this regard the instant invention substantially fulfills these needs.

### SUMMARY OF THE INVENTION

In view of the foregoing disadvantages inherent in the known types of retractable privacy and weather screens for railings now present in the prior art, the present invention provides a retractable screen for a railings wherein the same can be utilized for providing convenience for the user when enabling users to enjoy either the breeze and the view, or enable privacy and protection as desired.

It is therefore an object of the present invention to provide a new and improved retractable privacy screen for deck railings that has all of the advantages of the prior art and none of the disadvantages.

It is therefore an object of the present invention to provide a retractable privacy and weather screen useable on the railing of an outdoor deck or balcony to protect against the elements and limit vision therethrough from external onlookers.

Another object of the present invention is to provide a retractable privacy and weather screen that attaches to already existing deck or balcony hand rail spindles.

Another object of the present invention is to provide a retractable privacy and weather screen comprised of a weatherproof blind that is retractably extendable across a railing of a deck or balcony.

Yet another object of the present invention is to provide a retractable privacy and weather screen that is easily deployed and removed.

Another object of the present invention is to provide a retractable privacy and weather screen that is installable on residential and commercial decks and balconies, including either open rail or glass rail systems without requiring modification to the existing railing.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the present invention, comprising an elongated hollow tube, a longitudinal slot, a plurality of post attachments, a weatherproof sheet, a vertical support member, and a plurality of spindle clips.

FIG. 2 shows a perspective view of the present invention in a stowed position.

FIG. 3 shows a perspective view of the present invention attached to a railing post in the stowed position.

FIG. 4 shows a perspective view of the present invention attached to a railing post in an extended, working position.

### DETAILED DESCRIPTION OF THE PRESENT INVENTION

Reference is made herein to the attached drawings. Like reference numerals are used throughout the drawings to depict like or similar elements of the privacy and weather railing screen. For the purposes of presenting a brief and clear description of the present invention, the preferred embodiment will be discussed as used for providing shelter from environmental elements and privacy for a user, attachable to the railing of a deck or balcony. The figures are intended for representative purposes only and should not be considered to be limiting in any respect.

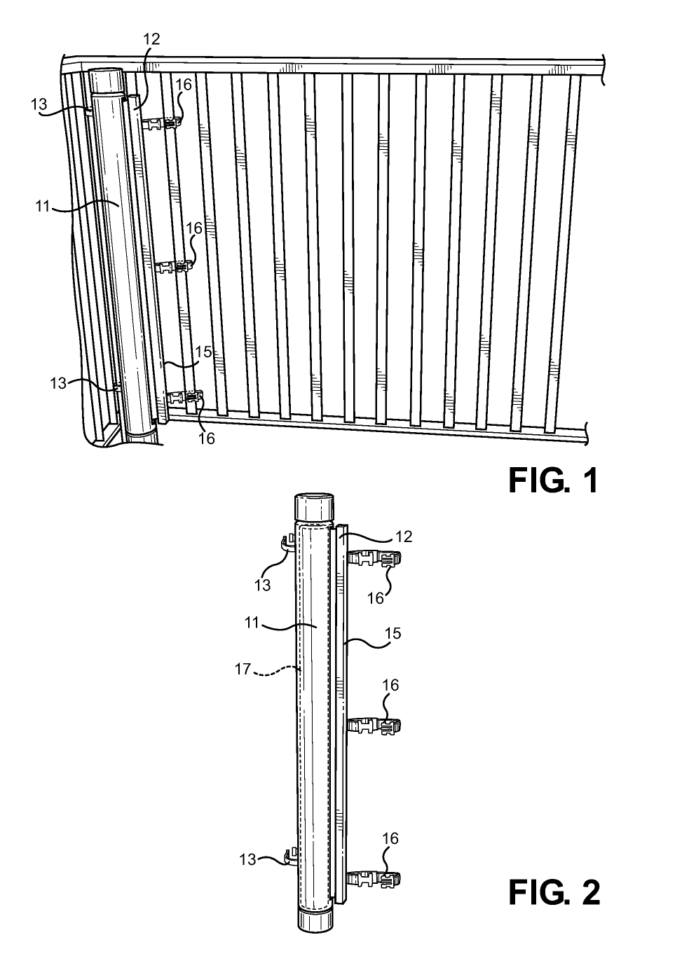

Referring now to FIG. 1 there is shown a perspective view of the present invention, comprising an elongated hollow tube 11 having an longitudinal slot 12, a plurality of post attachments 13, a vertical support member 15 and a plurality of spindle attachment clips 16. The hollow tube 11 contains a flexible sheet that is coiled around an elongated retractable roller 17 within the hollow tube 11. The sheet extends through the longitudinal slot 12 and extends into an outstretched position and retracts into a stowed position. The longitudinal slot 12 extends the length of the hollow tube 11. The vertical support member 15 is a thickened section of the sheet that maintains its cross section while in an extended, working position and has a width greater than the width of the opening in the longitudinal slot 12, thereby preventing the sheet 14 from retracting completely within the hollow tube 11. The support member 15 is a rigid structure that gives shape to the sheet 14 and functions as an attachment point for the spindle clips 16. The hollow tube 11 is a housing for which the sheet is wound around a centrally located roller within the tube. The roller attaches to a first end of the sheet, while the support member 15 attaches to a second end outside of the tube 11. The roller is a rotatable post within the tube that attaches to a retraction means preferably being a torsion spring to create tension on the sheet when in an extended, working position. The spring generates a return load as the roller is rotated, which works to draw the sheet back into the tube slot 12 and into a stowed position. The potential energy of the torsion spring therefore acts as an automatic return of the sheet and a means to support the sheet in a taught position extended with its support member 15 secured to a vertical spindle or railing.

Referring now to FIG. 2 there is shown a perspective view of the present invention in a stowed position. A plurality of post attachments 13 function as a means for supporting the hollow tube 11 in a vertical position, and comprise a set of clips, preferably side release buckles, that attach around a first deck railing post or spindle. The buckles are connected to the tube 11 by nylon webbing, thereby allowing for adjustment based on the size of the railing post. This enables the device to fit around various sized deck and balcony railing posts or spindles, and enables quick installation and removal of the device. The use of side release buckles allows for installation of the present invention without any modification to the deck or railing. Many of the inventions in the prior art require the installation of permanent fixtures, which are difficult to install and remove as needed. The present invention, however, can be installed and removed in a short period of time, and require no maintenance. The ability to mount the device without permanent modification further allows the device to be utilized on deck and balcony railings that are otherwise not permitted to be modified by a user, for instance apartments and rented home railings.

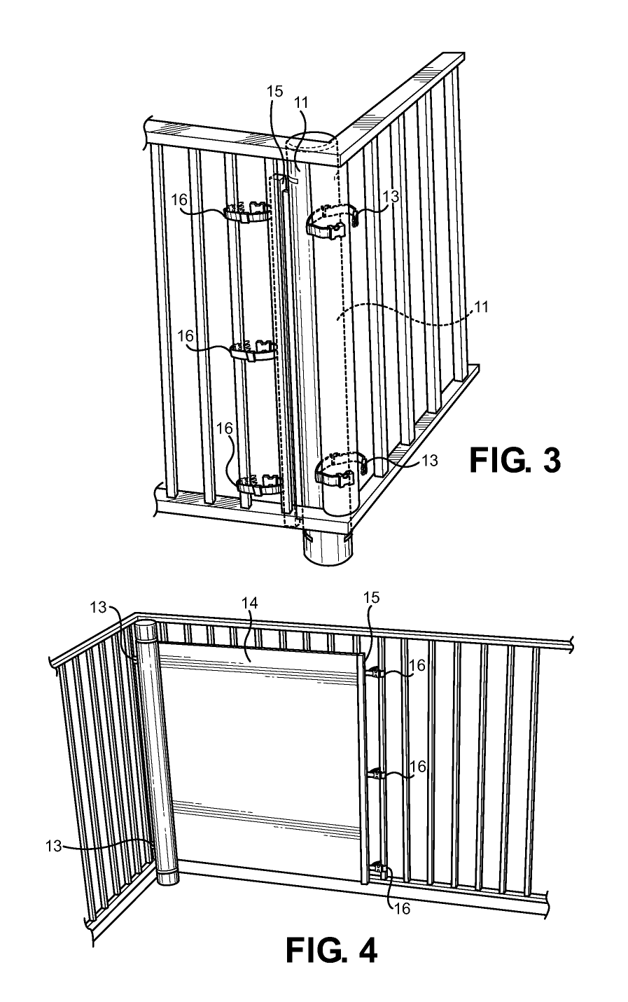

Referring now to FIG. 3, there is shown a perspective view of the present invention attached to a railing post in the stowed position. The sheet 14 is coiled around the internal roller within the hollow tube 11. The support member 15 rests against the longitudinal slot 12 with the spindle clips 16 in an unfastened position and is prevented from extending without sufficient force exerted thereon by a user. The hollow tube 11 is preferably made from a water impermeable construction or material, and is sealed at both ends to prevent water and debris from interfering with the internal roller mechanism. This design allows for storage of the device in the stowed position on the deck railing without requiring removal over an extended period of time. The hollow tube 11 may be provided in lengths based on the height of standard railings attached thereto; the standard railing height being typically between 36 and 42 inches. To place the device in an outstretched, working position, a user grasps and pulls the support member 15, which in turn releases the sheet 14 from inside the hollow tube 11. Once the sheet 14 is in the desired position, spindle clips 16 are secured around a second railing spindle.

FIG. 4 shows a perspective view of the present invention attached to a railing post and privacy and weather sheet 14 in a working position. The hollow tube attaches to a balcony or deck railing via a plurality of post attachments 13 that secure the tube in a static position by wrapping around a first railing post or spindle. An internal sheet 14 is extendable from the hollow tube and is held in an outstretched position by a plurality of spindle clips 16, which are preferably side release buckles or snaps. The spindle clips 16 function as an anchor means to lock the sheet 14 in an outstretched position by fastening around a second deck railing spindle or post. The support member 15 creates a rigid structure at the distal end of the sheet 14 to prevent folds or wrinkles in the sheet. The proximal end of the sheet 14 is held securely by the rotatable roller 17, which places tension on the sheet 14, allowing it to remain in a semi rigid state when extended. To place the sheet 14 in a stowed position, the spindle clips 16 are unfastened from the spindle and the roller retracts the extended portion of the sheet 14 into the tube slot 12.

The sheet 14 is preferably designed for protection from environmental elements, as well as for user privacy. Although it is not desired to limit the type of sheet material, the sheet 14 is preferably made of a weatherproof material that provides a barrier from the wind (i.e. densely woven or continuous material), rain (i.e. water impermeable) and flying debris (i.e. high strength material), and does not transmit light therethrough (i.e. opaque). The sheet 14 can be fabricated in a variety materials and colors in order to match the surrounding decor of the area or one that suits the user's preferences. In an alternative embodiment, the sheet 14 is fabricated from a translucent material to allow for viewing through the material while still providing protection from the wind

In an alternative embodiment of the present invention, the post attachments 13 and spindle clips 16 are comprised of a securing means that secures to glass hand railings, preferably suction cups. This allows the device to install on a deck that does not have a tubular spindle design. This makes the device suitable for users with glass railings who wish to add privacy to their decks. While decks with glass railings are adapted for protection against the wind, they afford no privacy to the user. By changing the attachment means to one suitable for glass hand railings, the present invention overcomes this problem.

The present invention provides a user with a convenient and easily installable device for protection against the elements, as well as a level of privacy. The device can be outstretched or stowed in a short period of time, thereby allowing a user to easily and quickly select his or her desired environment. The weatherproof design ensures that the device will be long lasting, and not require replacement at the end of a season of use, even when left outdoors for extended periods. The ability to match the device to the surround decor ensures that the present invention blends into the surrounding or decor of a home, and does not detract from its surroundings.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A retractable privacy and weather screen for a railing having vertical spindles, comprising:
an elongated hollow tube having two ends and a longitudinal slot therebetween, an attachment means for supporting said tube in a generally vertical position;
an internal roller rotatably mounted within said tube attached to a retraction means;
a flexible sheet being wound around said internal roller, said sheet having a distal end and a proximal end, said proximal end attached to said internal roller and said distal end adapted for extension through said longitudinal slot;
a vertical support member located on said sheet distal end, said vertical support having an anchor means.

2) A device as in claim 1, wherein said sheet in a first, stowed position being at least partially retracted within said elongated hollow tube and wound around said roller, and in a second, working position wherein said support member is extended at least partially beyond said tube slot.

3) A device as in claim 1, wherein said elongated hollow tube construction and material is water impermeable.

4) A device as in claim 1, wherein said attachment means for supporting said tube being made of a plurality of quick release side buckles attachable to a vertical deck member being a post or spindle.

5) A device as in claim 1, wherein said anchor means being made of a plurality of quick release side buckles attachable to a vertical deck member being a post or spindle.

6) A device as in claim 1, wherein said flexible material being made of opaque material.

7) A device as in claim 1, wherein said anchor means being made of a material attachable and removable from a glass surface.

8) A device as in claim 7, wherein said anchor means comprising suction cups.

9) A device as in claim 1, wherein said retraction means comprising a torsion spring that resists rotation of said internal roller when rotated from a first, stowed position to a second, working position.
